(19) United States
(12) Patent Application Publication
(10) Pub. No.: US 2018/0157802 A1
(43) Pub. Date: Jun. 7, 2018

(54) RISK EVALUATION METHOD, RISK EVALUATION DEVICE, AND STORAGE MEDIUM

(71) Applicant: FUJITSU LIMITED, Kawasaki-shi (JP)

(72) Inventor: Akira Karasudani, Yamato (JP)

(73) Assignee: FUJITSU LIMITED, Kawasaki-shi (JP)

(21) Appl. No.: 15/818,025

(22) Filed: Nov. 20, 2017

(30) Foreign Application Priority Data
Dec. 1, 2016 (JP) 2016-234442

(51) Int. Cl. G06F 19/00

(52) U.S. Cl. CPC G06F 19/3431

(57) ABSTRACT

A risk evaluation method executed by a processor included in a risk evaluation device, the risk evaluation method includes receiving, from a terminal device that includes a sensor and that is configured to receive a service, sensor information acquired by the sensor during a time period between sensing of a transition of a work situation and sensing of a subsequent transition, performed by the terminal device; calculating, from the received sensor information, a risk evaluation value obtained by indexing a risk around the terminal device; determining whether the risk evaluation value is less than or equal to a predetermined threshold value; and notifying a management device to manage the terminal device of information based on a result of the determining when it is determined that the risk evaluation value is less than or equal to the predetermined threshold value.

### CROSS-REFERENCE TO RELATED APPLICATION

This application is based upon and claims the benefit of priority of the prior Japanese Patent Application No. 2016-234442, filed on Dec. 1, 2016, the entire contents of which are incorporated herein by reference.

### FIELD

The embodiments discussed herein are related to a risk evaluation method, a risk evaluation device, and a storage medium.

### BACKGROUND

Information having a high level of privacy is handled under a rule set by an operator by performing a risk analysis in accordance with various guidelines. In a field of, for example, home healthcare, a rule used for using services for handling care information related to patients is set in accordance with a guideline defined by Ministry of Health, Labor and Welfare or the like.

In order to use a service, a condition that a healthcare practitioner stays in a patient's home is imposed as a rule in some cases, for example. In a case where the healthcare practitioner goes on a visit to the patient's home under such a rule setting, a home healthcare support system displays, on a smart terminal or the like used by the healthcare practitioner, care information of the patient to whom the healthcare practitioner goes on a visit. After that, in a case where the healthcare practitioner completes a visit and leaves the patient's home, the home healthcare support system erases, from the smart terminal, the care information of the relevant patient. For this reason, an improvement of security is achieved. As examples of the related arts, Japanese Laid-open Patent Publication No. 2010-152660, Japanese Laid-open Patent Publication No. 2005-63292, Japanese Laid-open Patent Publication No. 2005-242545, and so forth are disclosed.

However, in the above-mentioned technique, it is difficult to adequately correct the rule, in some cases.

In other words, an operational rule and an actual situation in which a service is used in an actual scene do not conform to each other, in some cases. In a case where these two do not conform to each other, even though the rule is to be corrected in conformity with the actual situation of the actual scene, an operator does not have a lot of knowledge or a lot of experience, related to the actual scene, in some cases. Therefore, it is difficult for the operator to understand a risk that occurs due to the use of the service in a situation in which the healthcare practitioner works in the actual scene. Accordingly, it is difficult for the operator to accurately perform risk analysis and to adequately correct the rule. In view of the above, it is desirable that it is possible to adequately correct the rule.

### SUMMARY

According to an aspect of the invention, a risk evaluation method executed by a processor included in a risk evaluation device, the risk evaluation method includes receiving, from a terminal device that includes a sensor and that is configured to receive a service, sensor information acquired by the sensor during a time period between sensing of a transition of a work situation and sensing of a subsequent transition, performed by the terminal device; calculating, from the received sensor information, a risk evaluation value obtained by indexing a risk around the terminal device; determining whether the risk evaluation value is less than or equal to a predetermined threshold value; and notifying a management device to manage the terminal device of information based on a result of the determining when it is determined that the risk evaluation value is less than or equal to the predetermined threshold value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of a system according to a first embodiment;

FIG. 2A is a diagram illustrating an example of a reception pattern of a BLE beacon;

FIG. 2B is a diagram illustrating an example of the reception pattern of the BLE beacon;

FIG. 2C is a diagram illustrating an example of the reception pattern of the BLE beacon;

FIG. 3 is a diagram illustrating an example of rule information;

FIG. 4 is a diagram illustrating an example of visiting medical care;

FIG. 5 is a diagram illustrating an example of log information;

FIG. 6 is a diagram illustrating an example of risk evaluation information;

FIG. 7 is a diagram illustrating an example of the risk evaluation information;

FIG. 8 is a flowchart illustrating a procedure of risk evaluation processing according to the first embodiment;

FIG. 9 is a flowchart illustrating a procedure of determination processing according to the first embodiment; and

FIG. 10 is a diagram illustrating an example of a hardware configuration of a computer to execute a risk evaluation program according to the first embodiment and a second embodiment.

### DESCRIPTION OF EMBODIMENTS

Hereinafter, a risk evaluation device, a risk evaluation method, and a risk evaluation program according to the present application will be described with reference to accompanying drawings. These embodiments do not limit the disclosed technology. In addition, the individual embodiments may be arbitrarily combined within a scope which does not cause a contradiction between processing contents.

### First Embodiment

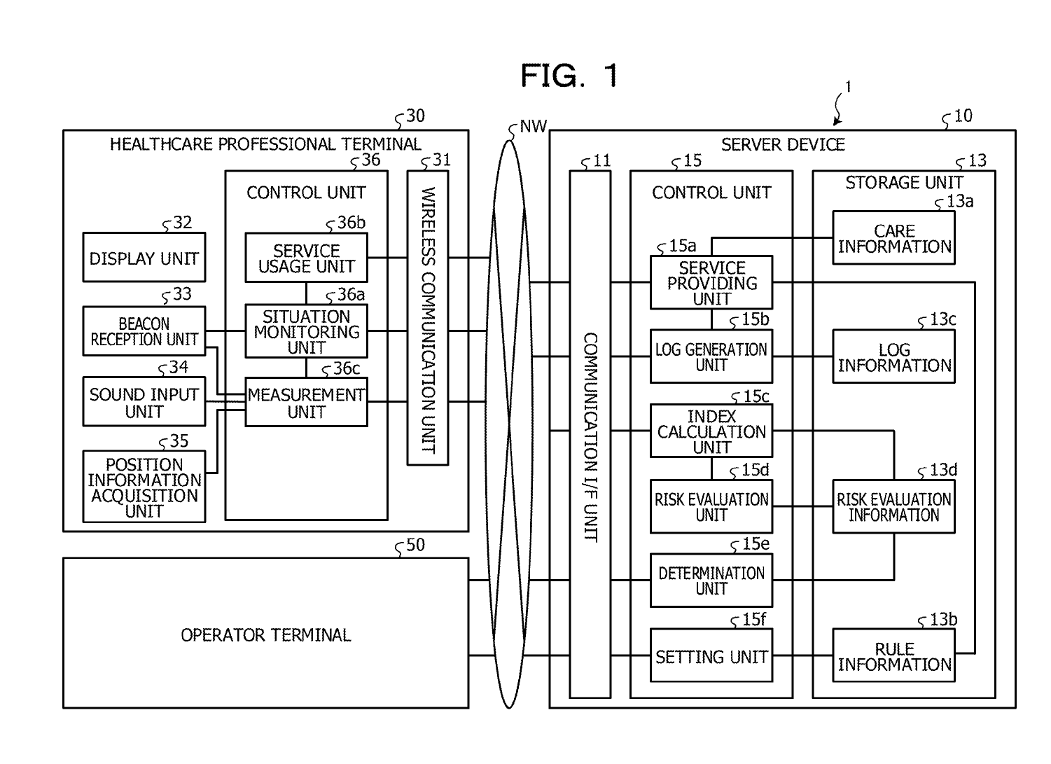

FIG. 1 is a diagram illustrating an example of a functional configuration of a system according to a first embodiment. A home healthcare support system 1 illustrated in FIG. 1 provides services for displaying care information related to patients, under a rule set by an operator in accordance with a predetermined guideline, thereby supporting home healthcare. As part of such home healthcare support, the home healthcare support system 1 implements a function of evaluating a risk caused by the use of a service in a situation in which a work is performed in an actual scene.

As illustrated in FIG. 1, the home healthcare support system 1 includes a server device 10, a healthcare professional terminal 30, and an operator terminal 50. FIG. 1 exemplifies one healthcare professional terminal 30 and one operator terminal 50. However, healthcare professional terminals 30 and operator terminals 50 may be installed for one server device 10.

The server device 10, the healthcare professional terminal 30, and the operator terminal 50 are coupled to one another via a predetermined network NW. Regardless of being wired or wireless, this network NW may be constructed by an arbitrary type of communication network such as the Internet, a local area network (LAN), or a virtual private network (VPN).

The server device 10 is a computer to realize the above-mentioned home healthcare support.

As one embodiment, the server device 10 may be implemented by installing, in a desired computer, a home healthcare support program that serves as package software or online software and that realizes various functions related to the above-mentioned home healthcare support, example of the various functions including, in addition to the above-mentioned service, a setting of a rule for using the above-mentioned service, inputting of medical records, and a scheduler for visiting medical care. The server device 10 may be implemented as a Web server to provide the functions of the above-mentioned home healthcare support, for example. Alternatively, the server device 10 may be implemented as a cloud to provide the functions of the above-mentioned home healthcare support by using outsourcing.

While the healthcare professional terminal 30 is used by healthcare practitioners, the operator terminal 50 is used by the operator of the above-mentioned service. The term “healthcare practitioners” here means, in addition to doctors, healthcare workers such as nurses and care persons, and general staffs who support them from a clerical job side or a system side.

As the healthcare professional terminal 30 and the operator terminal 50, mobile communication terminals such as smartphones, mobile phones, or personal handyphone systems (PHSs) or mobile terminal devices such as slate terminals or tablet terminals may be adopted.

Here, in the healthcare professional terminal 30, the above-mentioned service is used in accordance with a rule set in the server device 10 by the operator via the operator terminal 50. In other words, the care information includes pieces of personal information each having a high level of privacy of a patient, such as medical records, information for nursing care, and medical agents. Therefore, as an example, the rule is set by the operator in accordance with “Security Guidelines for Health Information Systems” of Ministry of Health, Labor and Welfare.

In a case where the rule is set in this way, situations in which healthcare practitioners perform works related to home healthcare are narrowed down to a situation for allowing a service to be used, from a security perspective. In other words, in the home healthcare, in addition to a situation in which a healthcare practitioner provides medical care in a patient's home, there are a situation of traveling on foot from a hospital, a medical office, or the like to a patient' home, a situation of traveling with taking a ride in a vehicle owned by a business operator of a hospital, a medical office, or the like, and so forth. These situations in which works such as medical care, traveling on foot, and traveling by a vehicle are performed are described as “work situations” in some cases. At least a situation that is included in these work situations and in which a healthcare practitioner provides medical care to a patient is equivalent to a safe state in which the healthcare practitioner stays in the patient' home. Therefore, a rule for allowing a service to be used is set.

It is possible to realize identification of such a work situation by using, as an example, a Bluetooth (registered trademark) Low Energy (BLE) beacon or an Internet of Things (IoT) device such as a near field communication (NFC) tag. In what follows, as just an example, a case of identifying a work situation of a healthcare practitioner by using a BLE beacon will be exemplified.

In a case of using, for example, the BLE beacon, the healthcare professional terminal 50 able to receive the BLE beacon is diverted as a beacon receiver, and a portable beacon transmitter carried by a healthcare practitioner and a stationary beacon transmitter installed in a location in which a healthcare practitioner performs a work related to home healthcare are used as beacon transmitters. Hereinafter, the BLE beacon transmitted by the portable beacon transmitter is described as a “healthcare practitioner beacon”, and the BLE beacon transmitted by the stationary beacon transmitter is described as a “location beacon”, in some cases. Based on whether or not one or the two of the healthcare practitioner beacon and the location beacon are received by the healthcare professional terminal 30, a work situation of the healthcare practitioner is identified.

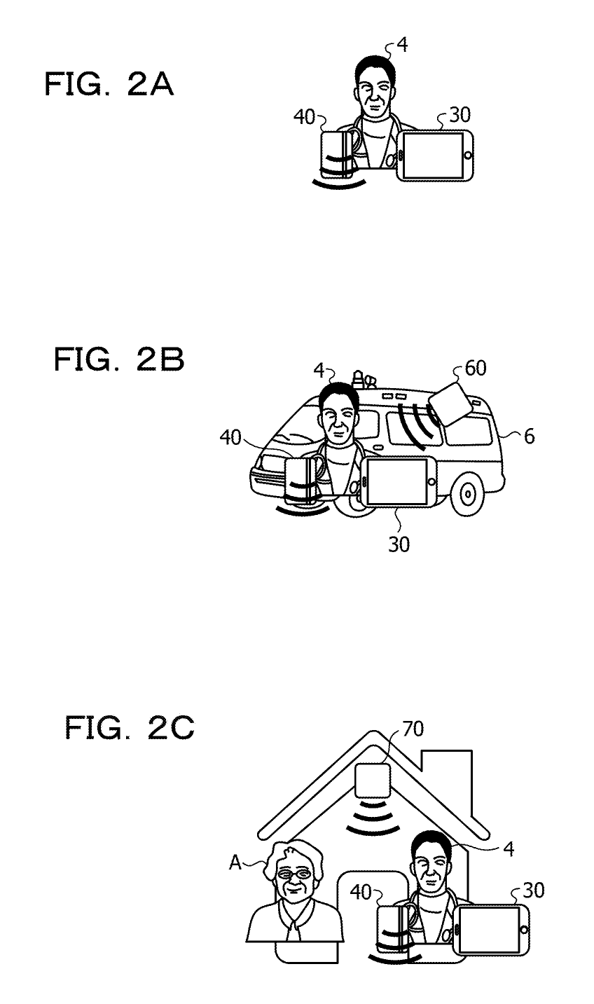

Each of FIG. 2A, FIG. 2B, and FIG. 2C is a diagram illustrating an example of a reception pattern of the BLE beacon. These FIG. 2A, FIG. 2B, and FIG. 2C each illustrate an example in which a healthcare practitioner 4 carries the healthcare professional terminal 30 and a card-type beacon transmitter 40 during work. As an example of the stationary beacon transmitter, FIG. 2B illustrates an example in which a beacon transmitter 60 is installed in a vehicle 6 owned by a hospital or a medical office. As an example of the stationary beacon transmitter, FIG. 2C illustrates an example in which a beacon transmitter 70 is installed in a patient's home that is a home of a patient A.

As illustrated in FIG. 2A, in a case where the healthcare professional terminal 30 only receives the healthcare practitioner beacon from the card-type beacon transmitter 40, it is understood that the healthcare practitioner exists in none of the vehicle 6 and the patient's home while being engaged in visiting medical care. In this case, it is possible to identify that a work situation of the healthcare practitioner is “currently traveling on foot”. As illustrated in FIG. 2B, in a case where the healthcare professional terminal 30 receives the healthcare practitioner beacon from the card-type beacon transmitter 40 and receives, as the location beacon, a vehicle beacon from the stationary beacon transmitter 60, it is possible to understand a situation in which the healthcare practitioner is engaged in visiting medical care and exists in the vehicle 6. In this case, it is possible to identify that a work situation of the healthcare practitioner is at least “currently taking a ride (staying) in a vehicle” no matter if the vehicle 6 is parked or running. Furthermore, as illustrated in FIG. 2C, in a case where the healthcare professional terminal 30 receives the healthcare practitioner beacon from the card-type beacon transmitter 40 and receives, as the location beacon, a patient's home beacon from the stationary beacon transmitter 70, it is possible to understand a situation in which the healthcare practitioner is engaged in visiting medical care and exists in the patient's home of the patient A. In this case, it is possible to identify that a work situation of the healthcare practitioner is “currently providing medical care”.

In this way, based on whether the type of beacon received by the healthcare professional terminal 30 corresponds to one of patters of “the healthcare practitioner beacon”, “the healthcare practitioner beacon+the vehicle beacon”, and “the healthcare practitioner beacon+the patient's home beacon”, it is possible to identify the work situation of the healthcare practitioner. In a case of “currently providing medical care” out of these work situations, a service is allowed to be used in the healthcare professional terminal 30.

While an illustration is omitted, in a case where it is difficult for the healthcare professional terminal 30 to receive the healthcare practitioner beacon, the healthcare practitioner is in a situation of not existing beside the healthcare professional terminal 30. Therefore, it is possible to identify that the healthcare professional terminal 30 is at risk for being lost. In this case, if a situation in which it is difficult for the healthcare professional terminal 30 to receive the healthcare practitioner beacon continues for a predetermined time period, it is possible to notify the operator terminal 50 of an alert for risk for a loss.

First, a functional configuration of the healthcare professional terminal 30 according to the present embodiment will be described. As illustrated in FIG. 1, the healthcare professional terminal 30 includes a wireless communication unit 31, a display unit 32, a beacon reception unit 33, a sound input unit 34, a location information acquisition unit 35, and a control unit 36. In addition to the functional units illustrated in FIG. 1, the healthcare professional terminal 30 may include various functional units included in a known mobile terminal device, such as, for example, an antenna, an input unit, and a sound output unit.

The wireless communication unit 31 is a processing unit coupled to a base station via an antenna not illustrated, thereby transmitting and receiving pieces of data to and from another device via a mobile communication network or the like coupled to the base station, examples of the other device including the server device 10 and the operator terminal 50.

The display unit 32 is a device to display various kinds of information.

As an embodiment, the display unit 32 may be integrated with an input unit not illustrated, thereby being implemented as a touch panel, and may be implemented by using a liquid crystal display, an organic electroluminescence (EL) display, or the like. In addition to such displays that each realize display by emission of light, the display unit 32 may be implemented as a projector to realize display by projection. The display unit 32 is able to display care information used for medical care of a patient, in accordance with an instruction from a service usage unit 36b to be described later, for example.

The beacon reception unit 33 is a processing unit to receive a beacon. While, here, a function of receiving the beacon will be described, a function of transmitting the beacon may be concurrently included.

As one embodiment, the beacon reception unit 33 may be implemented by a BLE chip or the like, equipped with a function of short distance wireless communication. The beacon reception unit 33 receives the healthcare practitioner beacon from the card-type beacon transmitter 40, receives the vehicle beacon from the stationary beacon transmitter 60, and receives the patient's home beacon from the stationary beacon transmitter 70, for example. Upon receiving one of these BLE beacons, the beacon reception unit 33 notifies a measurement unit 36c to be described later of a reception radio wave intensity of the currently received BLE beacon. Here, a case of using Bluetooth (registered trademark) is exemplified. However, the beacon may be received based on another standard of short distance wireless communication.

The sound input unit 34 is a processing unit to input a sound signal.

As one embodiment, the sound input unit 34 may be implemented by using a microphone or the like able to convert sound into an electric signal. After converting, into a digital signal, an analog signal obtained by collecting sound via the microphone, the sound input unit 34 inputs, as sound data, the digital signal to the measurement unit 36c, for example.

The location information acquisition unit 35 is a processing unit to acquire location information.

As one embodiment, the location information acquisition unit 35 may be implemented by a global positioning system (GPS) receiver to measure a location from pieces of time information transmitted by GPS satellites, or the like. The location information acquisition unit 35 inputs, to the measurement unit 36c, location information measured by a GPS receiver, for example. While, here, the GPS receiver is exemplified as an example of a sensor for acquiring the location information, the sensor is not limited to this. Location information of a base station of a cell containing the healthcare professional terminal 30 may be acquired, for example, examples of the base station including an access point. The location information of this access point may be used as location information of the healthcare practitioner without change. Alternatively, a distance between the healthcare professional terminal 30 and the access point, determined from a reception radio wave intensity of the healthcare professional terminal 30 or the like, may be used, thereby obtaining the location information of the healthcare professional terminal 30.

The control unit 36 is a processing unit to control the entire healthcare professional terminal 30.

As one embodiment, the control unit 36 may be implemented by a hardware processor such as a central processing unit (CPU) or a micro processing unit (MPU). While, here, the CPU and the MPU are exemplified as examples of the processor, the control unit 36 may be implemented by an arbitrary processor no matter if the processor is a general one or a specific one. In addition to this, the control unit 36 may be realized by a hard-wired logic such as an application specific integrated circuit (ASIC) or a field programmable gate array (FPGA).

The control unit 36 deploys a service usage program for a terminal, on a work area of a RAM such as a dynamic random access memory (DRAM) or a static random access memory (SRAM), mounted as a main storage device not illustrated, thereby virtually realizing processing units to be described below.

As illustrated in FIG. 1, the control unit 36 includes a situation monitoring unit 36a, the service usage unit 36b, and the measurement unit 36c.

The situation monitoring unit 36a is a processing unit to monitor a transition of the above-mentioned work situation.

As one embodiment, the situation monitoring unit 36a downloads, from the server device 10, rule information corresponding to an account assigned to a healthcare practitioner who uses the healthcare professional terminal 30, and stores the downloaded rule information in a work area of an internal memory not illustrated. Under a condition in which the rule information is downloaded in this way, the situation monitoring unit 36a determines whether or not a healthcare practitioner beacon or a patient's home beacon, received by the beacon reception unit 33, is a BLE beacon corresponding to a healthcare practitioner or a patient, specified in the rule information. In other words, whether identification information of a healthcare practitioner, included in the healthcare practitioner beacon, is coincident with a healthcare practitioner specified in the rule information is checked, and whether identification information of a patient, included in the patient's home beacon, is coincident with one of patients specified in the rule information is checked. For this reason, whether a healthcare practitioner uses the healthcare professional terminal 30 for which the healthcare practitioner has no right to use it is confirmed, and furthermore, whether a healthcare practitioner goes on a visit to a patient's home of a patient for which the healthcare practitioner is not responsible is confirmed. In a case where one of the healthcare practitioner beacon and the patient's home beacon corresponds to no healthcare practitioner and no patient, specified in the rule information, an alert warning is displayed on the display unit 32.

On that basis, the situation monitoring unit 36a identifies one of patterns of “the healthcare practitioner beacon”, “the healthcare practitioner beacon+the vehicle beacon”, and “the healthcare practitioner beacon+the patient's home beacon”, to which a reception pattern of the beacon received by the beacon reception unit 33 corresponds. On that basis, the situation monitoring unit 36a determines whether or not the reception pattern of the beacon, obtained by the identification at this time, and a reception pattern of a beacon, obtained by identification at a previous time, are coincident with each other.

Here, in a case where the reception patterns of the two beacons are different from each other, it is possible to sense that a transition of a work situation is made. In this case, the situation monitoring unit 36a notifies the server device 10 of a work situation after the transition. Furthermore, the situation monitoring unit 36a causes measurement information to be uploaded to the server device 10, the measurement information being measured by the measurement unit 36c between sensing of a transition of a work situation at a previous time and a transition of the work situation at this time.

On the other hand, in a case where the reception patterns of the two beacons are identical to each other, the situation monitoring unit 36a further determines whether or not the reception pattern of the relevant beacon is “the healthcare practitioner beacon+the vehicle beacon”, in other words, whether or not the work situation is “currently taking a ride in a vehicle”. At this time, in a case where the work situation is “currently taking a ride in a vehicle”, it is determined whether a cumulative movement distance is less than a predetermined threshold value, for example, 5 meters, the cumulative movement distance being obtained from a trajectory of location information measured by the location information acquisition unit 35 over a previous predetermined time period, for example, a time period long enough to keep from being falsely recognized as waiting for a traffic light. In addition, in a case where the movement distance is less than the threshold value, the situation monitoring unit 36a identifies that the work situation is “a vehicle is currently parked”. On the other hand, in a case where the movement distance is not less than the threshold value, the situation monitoring unit 36a identifies that the work situation is “a vehicle is running”. On that basis, in a case where a transition from the work situation identified at the previous time is made, the situation monitoring unit 36a notifies the server device 10 of a work situation after the transition. Furthermore, the situation monitoring unit 36a causes measurement information to be uploaded to the server device 10, the measurement information being measured by the measurement unit 36c between the sensing of a transition of the work situation at the previous time and a transition of the work situation at this time. The reason why “currently taking a ride in a vehicle” is further classified to “a vehicle is currently parked” and “a vehicle is running” in this way is that a time at which a vehicle is running and which is likely to lead to an accident and a time at which a vehicle is parked and which is less likely to lead to an accident than the time at which a vehicle is running are discriminated from each other, thereby implementing a risk analysis.

The service usage unit 36b is a processing unit to use the above-mentioned service.

As one embodiment, every time the situation monitoring unit 36a senses a transition of the work situation, the service usage unit 36b determines whether or not a work situation after the transition conforms to a condition defined by the rule information. If it is assumed that a work situation in which a service is allowed to be used is specified, as a condition, in the rule information, in a case where the work situation after the transition conforms to the condition specified in the rule information, it turns out that a transition is made to a work situation in which a service is allowed to be used, for example. In this case, the service usage unit 36b initiates the use of a service that is included in services defined in the rule information and that is associated with the relevant work situation. Here, as an example of the rule information, information for specifying work situations in which services are allowed to be used, in other words, a positive list, is exemplified. However, information for specifying work situations in which no services are allowed to be used, in other words, a negative list, may be adopted. In this case, by focusing on a case where the work situation after the transition conforms to no condition defined in the rule information, the use of a service only has to be initiated.

In other words, the service usage unit 36b downloads, from the server device 10, care information corresponding to the relevant service and saves the care information on a secret area having a tamper-resistant property. This secret area may be constructed as a memory different from the above-mentioned internal memory, or a partial area of the internal memory may be used as the secret area. On that basis, the service usage unit 36b causes the display unit 32 to display the care information saved on the above-mentioned secret area. Browsing and editing of the care information saved on the secret area in this way are allowed to be performed over a time period of a continuation of a work situation in which a service is allowed to be used. After that, in a case where a transition of the work situation is sensed, the service usage unit 36b inhibits the browsing and editing of the care information saved on the secret area from being performed and further deletes the care information after uploading, to the server device 10, the care information saved on the secret area.

Here, as just an aspect, by focusing on a time period of a continuation of a work situation in which a service is allowed to be used, a case of allowing the care information saved on the secret area to be accessed is exemplified. However, an access to the secret area after the transition of the work situation, in other words, service usage outside a rule, does not have to be totally inhibited. The reason is that if the service usage outside a rule is excessively restricted, it is difficult to adjust to an unexpected situation, or interference with an operation occurs, in some cases. Therefore, by focusing on a predetermined time period after a work situation in which a service is allowed to be used makes a transition to another work situation, the service usage unit 36b may allow service usage outside a rule with a condition of a success in authentication processing such as pattern authentication, password authentication, or biometric authentication, outputting, to the server device 10, of an alert for an access outside a rule, and so forth.

The measurement unit 36c is a processing unit to control measurements based on sensors such as the beacon reception unit 33, the sound input unit 34, and the location information acquisition unit 35.

As one embodiment, every time the situation monitoring unit 36a senses a transition of the work situation, the measurement unit 36c causes pieces of measurement information to be uploaded to the server device 10, the pieces of measurement information being caused to be measured by the beacon reception unit 33, the sound input unit 34, and the location information acquisition unit 35 between sensing of a transition of the work situation at a previous time and a transition of the work situation at this time. As examples of such pieces of measurement information, the reception radio wave intensity of a BLE beacon, measured by the beacon reception unit 33, sound data measured by the sound input unit 34, location information measured by the location information acquisition unit 35, and so forth are uploaded to the server device 10.

Subsequently, a functional configuration of the server device 10 according to the present embodiment will be described. As illustrated in FIG. 1, the server device 10 includes a communication interface (I/F) unit 11, a storage unit 13, and a control unit 15. In addition to the functional units illustrated in FIG. 1, the server device 10 may include various functional units included in a known computer, such as, for example, an input unit and an output unit.

The communication I/F unit 11 is an interface to control communication with other devices such as, for example, the healthcare professional terminal 30 and the operator terminal 50.

As one embodiment, a network interface card such as a LAN card may be adopted as the communication I/F unit 11. The communication I/F unit 11 receives, from the healthcare professional terminal 30, a transition notification of a work situation and the measurement information and transmits, to the healthcare professional terminal 30, the rule information and the care information, for example. The communication I/F unit 11 transmits a proposal notification of rule correction to the operator terminal 50 and receives a correction instruction for a rule from the operator terminal 50.

The storage unit 13 is a storage device to store therein data used for various programs such as application programs for realizing the above-mentioned functions of the home healthcare support, the various programs including an operating system (OS) executed by the control unit 15.

As one embodiment, the storage unit 13 may be implemented as an auxiliary storage device in the server device 10. A hard disk drive (HDD), an optical disk, a solid state drive (SSD), or the like may be adopted as the storage unit 13, for example. The storage unit 13 does not have to be implemented as an auxiliary storage device and may be implemented as a main storage device in the server device 10. In this case, one of various semiconductor memory elements such as, for example, a RAM and a flash memory may be adopted as the storage unit 13.

As examples of pieces of data used for programs executed by the control unit 15, the storage unit 13 stores therein care information 13a, rule information 13b, log information 13c, and risk evaluation information 13d. In addition to these pieces of data, the following pieces of electronic data may be stored. Account information of healthcare practitioners and operators may be stored along with information such as identification information for identifying the healthcare professional terminal 30 and the operator terminal 50, for example. Explanations of the log information 13c and the risk evaluation information 13d will be described later in combination with an explanation of the control unit 15 to generate the log information 13c and the risk evaluation information 13d.

The care information 13a is information related to home healthcare. The care information 13a includes health care records of patients such as so-called medical records, nursing care records, and inspection results, for example. As an example, this care information 13a is saved in a state of being able to be called from the storage unit 13 by specifying, as a query, identification information for identifying a patient, examples of the identification information including a patient identification (ID), a name and a birth date of the patient, and so forth.

The rule information 13b is information in which a condition for using a service is defined.

As one embodiment, data in which items such as a rule ID, a condition, and a service are associated with one another may be adopted as the rule information 13b. The term “rule ID” here means identification information of a rule. The term “condition” means a condition imposed for using a service and is described based on, for example, a positive list method. The term “service” means a service allowed to be used in a case where the condition is satisfied.

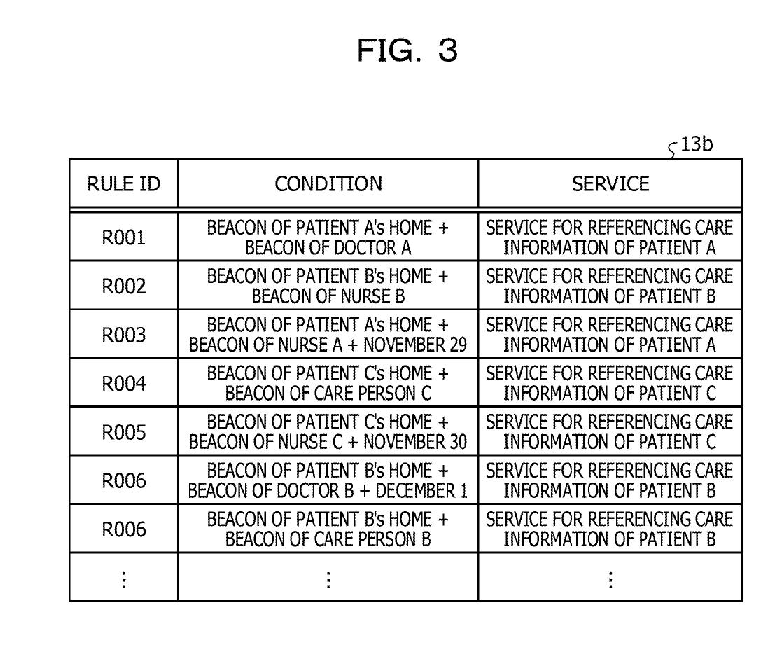

FIG. 3 is a diagram illustrating an example of the rule information 13b. An example of a rule identified by a rule ID “R001” illustrated in FIG. 3 means that, in a case where a condition that the healthcare professional terminal 30 receives the healthcare practitioner beacon of a doctor A and the patient's home beacon of a patient A's home is satisfied, in other words, in a case where a condition that the work situation of the doctor A is “currently providing medical care” to the patient A is satisfied, a service for referencing the care information of the patient A is allowed to be used. An example of a rule identified by a rule ID “R002” illustrated in FIG. 3 means that, in a case where a condition that the healthcare professional terminal 30 receives the healthcare practitioner beacon of a nurse B and the patient's home beacon of a patient B's home is satisfied, in other words, in a case where a condition that the work situation of the nurse B is “currently providing medical care” to the patient B is satisfied, a service for referencing the care information of the patient B is allowed to be used. An example of a rule identified by a rule ID “R003” illustrated in FIG. 3 means that, in a case where a condition that the healthcare professional terminal 30 receives the healthcare practitioner beacon of a nurse A and the patient's home beacon of the patient A's home is satisfied, in other words, in a case where a condition that the work situation of the nurse A is “currently providing medical care” to the patient A is satisfied and a condition that a date and time is November 29 is satisfied, a service for referencing the care information of the patient A is allowed to be used.

In this way, in FIG. 3, a rule in which a combination of a healthcare practitioner and a patient is specified and in which a work situation is “currently providing medical care” is set. In addition, in some rules, dates and times when services are allowed to be used are further set. In addition to such dates and times, another time condition, for example, a condition related to a day of the week, a time zone, or the like may be specified.

The control unit 15 is a processing unit to control the entire server device 10.

As one embodiment, the control unit 15 may be implemented by a hardware processor such as a CPU or an MPU. Here, the CPU and the MPU are exemplified as examples of the processor. However, the control unit 15 may be implemented by an arbitrary processor no matter if the processor is a general one or a specific one. In addition to this, the control unit 15 may be realized by a hard-wired logic such as an ASIC or an FPGA.

The control unit 15 deploys a home healthcare support program on a work area of a RAM such as a DRAM or an SRAM, mounted as a main storage device not illustrated, thereby virtually realizing processing units to be described below.

As illustrated in FIG. 1, the control unit 15 includes a service providing unit 15a, a log generation unit 15b, an index calculation unit 15c, a risk evaluation unit 15d, a determination unit 15e, and a setting unit 15f.

The service providing unit 15a is a processing unit to provide services to the healthcare professional terminal 30.

As one aspect, in a case where a request to download the rule information is received from the healthcare professional terminal 30, the service providing unit 15a delivers, to the healthcare professional terminal 30, the rule information corresponding to an account assigned to a healthcare practitioner serving as a user of the relevant healthcare professional terminal 30. As illustrated in, for example, FIG. 3, the rule information 13b includes rules related to healthcare practitioners. However, in a case where the rule information 13b is delivered without change, rules unrelated to the user of the healthcare professional terminal 30 turn out to be delivered. Therefore, after extracting, from the rule information 13b, a rule including a condition corresponding to the healthcare practitioner serving as the user of the healthcare professional terminal 30, the service providing unit 15a delivers the relevant rule to the healthcare professional terminal 30.

As another aspect, in a case where a request to download the care information is received from the healthcare professional terminal 30, the service providing unit 15a transmits, to the healthcare professional terminal 30, the care information of a patient, which is included in the care information 13a stored in the storage unit 13 and which is specified by the relevant request. After that, in a case where the care information is updated through editing of a medical record, a nursing care record, and so forth, the service providing unit 15a reflects, in the care information 13a stored in the storage unit 13, an updated portion of the care information transmitted by the healthcare professional terminal 30.

The log generation unit 15b is a processing unit to generate the log information 13c.

As one embodiment, every time the healthcare professional terminal 30 gives notice of a transition of a work situation, the log generation unit 15b updates the log information 13c. In other words, in a case where the healthcare professional terminal 30 gives notice of a transition of a work situation, it turns out that a work situation a transition of which is given notice of at a previous time finishes and that the work situation a transition of which is given notice of at this time starts. Therefore, the log generation unit 15b describes an end time in a record which corresponds to the work situation a transition of which is given notice of at the previous time and which is included in the log information 13c stored in the storage unit 13, and creates a new record. Furthermore, the log generation unit 15b describes, in the new record, a start time along with the work situation a transition of which is given notice of at this time.

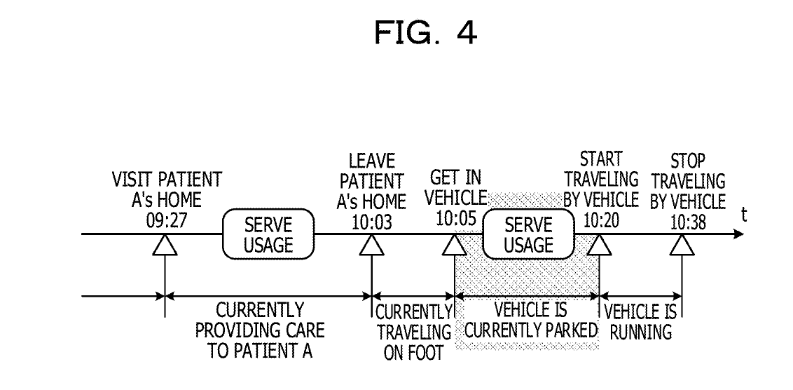

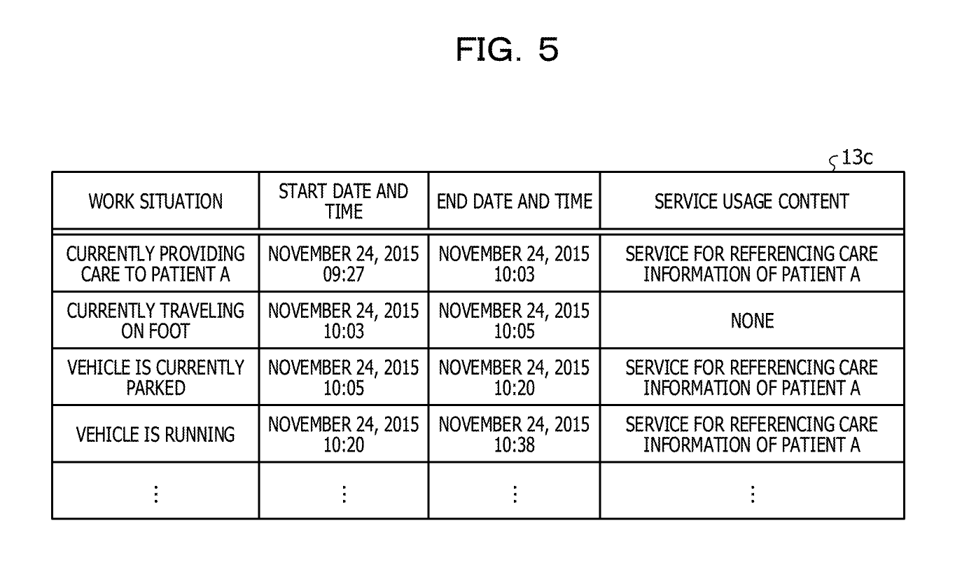

Hereinafter, specific examples of updating of the log information 13c will be described by using FIG. 4 and FIG. 5. FIG. 4 is a diagram illustrating an example of visiting medical care. FIG. 5 is a diagram illustrating an example of the log information 13c. As an example, FIG. 4 illustrates an example in which the doctor A performs visiting medical care of the patient A. FIG. 5 illustrates the log information 13c generated in a case where the visiting medical care illustrated in FIG. 4 is performed.

As illustrated in FIG. 4, the doctor A visits the patient A's home at 9:27 a.m. The healthcare practitioner beacon of the doctor A and the patient's home beacon of the patient A are received, thereby causing the healthcare professional terminal 30 to sense this transition of a work situation. As a result, the healthcare professional terminal 30 notifies the server device 10 of the work situation of “currently providing medical care to the patient A” after the transition. Accordingly, after a record in the first line illustrated in FIG. 5 is generated, “care of the patient A” is described in the work situation, and “9:27 a.m.” is described in the start date and time.

In a case where the visiting medical care of the patient A is started in this way, a service for referencing the care information of the patient A is used as illustrated in FIG. 4. Accordingly, in the record in the first line illustrated in FIG. 5, “a service for referencing the care information of the patient A” is described as the service usage content. After that, at 10:03 a.m., the doctor A leaves the patient A's home. A state in which the healthcare practitioner beacon of the doctor A and the patient's home beacon of the patient A are received changes to a state in which only the healthcare practitioner beacon of the doctor A is received, thereby causing the healthcare professional terminal 30 to sense this transition of a work situation. As a result, the healthcare professional terminal 30 notifies the server device 10 of the work situation of “currently traveling on foot” after the transition. Accordingly, “10:03 a.m.” is described in the end date and time in the record in the first line illustrated in FIG. 5, and a new record is generated in the second line. In this record in the second line, “currently traveling on foot” is described in the work situation, and “10:03 a.m.” is described in the start date and time.

Subsequently, as illustrated in FIG. 4, the doctor A gets in the vehicle at 10:05 a.m. A state in which only the healthcare practitioner beacon of the doctor A is received changes to a state in which the healthcare practitioner beacon of the doctor A and the vehicle beacon are received, thereby causing the healthcare professional terminal 30 to sense this transition of a work situation. As a result, the healthcare professional terminal 30 notifies the server device 10 of the work situation of “a vehicle is currently parked” after the transition. Accordingly, “10:05 a.m.” is described in the end date and time in the record in the second line illustrated in FIG. 5. Furthermore, since a service is not used during traveling on foot, “non” is described in the service usage content in the record at the second line illustrated in FIG. 5. Along with this, a new record is generated in the third line. In the record in the third line, “a vehicle is currently parked” is described in the work situation, and “10:05 a.m.” is described in the start date and time.

After the doctor A gets in the vehicle in this way, the doctor A uses a service for referencing the care information of the patient A outside a rule. Accordingly, in the record in the third line illustrated in FIG. 5, “a service for referencing the care information of the patient A” is described as the service usage content.

Subsequently, as illustrated in FIG. 4, the doctor A starts traveling by the vehicle at 10:20 a.m. While a state in which the healthcare practitioner beacon of the doctor A and the vehicle beacon are received does not change, a cumulative movement distance obtained from a trajectory of the location information exceeds the threshold value, thereby causing the healthcare professional terminal 30 to sense this transition of a work situation. As a result, the healthcare professional terminal 30 notifies the server device 10 of the work situation of “a vehicle is running” after the transition. Accordingly, “10:20 a.m.” is described in the end date and time in the record in the third line illustrated in FIG. 5, and a new record is generated in the fourth line. In this record in the fourth line, “a vehicle is running” is described in the work situation, and “10:20 a.m.” is described in the start date and time.

After that, as illustrated in FIG. 4, the doctor A stops traveling by the vehicle at 10:38 a.m. A state in which the healthcare practitioner beacon of the doctor A and the vehicle beacon are received changes to a state in which only the healthcare practitioner beacon of the doctor A is received, thereby causing the healthcare professional terminal 30 to sense this transition of a work situation. As a result, “10:38 a.m.” is described in the end date and time in the record in the fourth line illustrated in FIG. 5.

In this way, the log generation unit 15b is able to generate the log information 13c illustrated in FIG. 5 in conformity with a transition of the work situation, given notice of by the healthcare professional terminal 30.

Returning to the explanation of FIG. 1, the index calculation unit 15c is a processing unit to calculate an index for visualizing a risk from measurement information corresponding to an interval corresponding to a work situation.

Here, in order to realize a risk analysis of a work situation, in addition to a specification of a guideline, a knowledge of transforming, into an index, measurement information measurable around the healthcare professional terminal 30 is important, the index being able to be utilized for an analysis of risks such as a contact with another person and a loss.

As one aspect, from sound data collected by using a microphone, the index calculation unit 15c calculates the degree of congestion indicating the degree of congestion of the vicinity of the healthcare practitioner. The index calculation unit 15c divides the sound data by a predetermined unit time, for example, one minute, and performs the following processing on the divided sound data per unit time, for example. In other words, the index calculation unit 15c detects an utterance section from the sound data per unit time and extracts, as phonological features, feature amounts of a frequency characteristic, obtained by performing a frequency analysis on the utterance section, for example, mel-frequency cepstrum coefficients (MFCCs). Subsequently, the index calculation unit 15c classifies, into the same speaker, speakers having similar phonological features, thereby performing speaker clustering. Based on this speaker clustering, it is possible to identify the number of speakers for the sound data per unit time. On that basis, by performing predetermined statistical processing, for example, average processing, on the number of speakers identified for the sound data per unit time, the index calculation unit 15c is able to calculate, as the degree of congestion, the average number of persons (persons per minute) of speakers per unit time in the relevant work situation. It is possible to obtain, based on the speaker clustering, the degree of congestion from the sound data in this way, and furthermore, it is possible to calculate the degree of congestion from the sound data by using a technique disclosed in P. G. Kannan, “Low cost crowd counting using audio tones”.

Here, as an example, an example of calculating the degree of congestion by using the sound data is described. However, it is possible to calculate the degree of congestion by using measurement information measured by another sensor. From time-series data of an acceleration measured by a motion sensor such as an acceleration sensor, it is possible to estimate the degree of congestion, for example. In this case, as an example, by using a technique disclosed in Yonemura, “Proposal and Evaluation of Estimation Method for Human Congestion Using Smartphone”, it is possible to calculate the degree of congestion from the time-series data of an acceleration.

As another aspect, the index calculation unit 15c is able to calculate, from the reception radio wave intensity of the healthcare practitioner beacon, the degree of proximity indicating the degree of proximity of the healthcare practitioner to the healthcare professional terminal 30. The index calculation unit 15c calculates, as the degrees of proximity, the average and dispersion of the reception radio wave intensity measured during an interval corresponding to the work situation, for example.

As yet another aspect, the index calculation unit 15c is able to calculate, from changes in location information, the degree of movement indicating the degree of velocity at which the healthcare professional terminal 30 moves. The index calculation unit 15c calculates a cumulative movement distance from the trajectory of the location information measured during an interval corresponding to the work situation and calculates, as the degree of movement, a movement velocity obtained by dividing the relevant cumulative movement distance by a duration time of the work situation, in other words, a difference between a start time and an end time, for example.

The calculation of these indexes may be implemented every time a transition of the work situation is given notice of, and may be implemented, based on batch processing, at a regular time, for example, at a medical care closing time of home medical care or a business closing time of a healthcare practitioner.

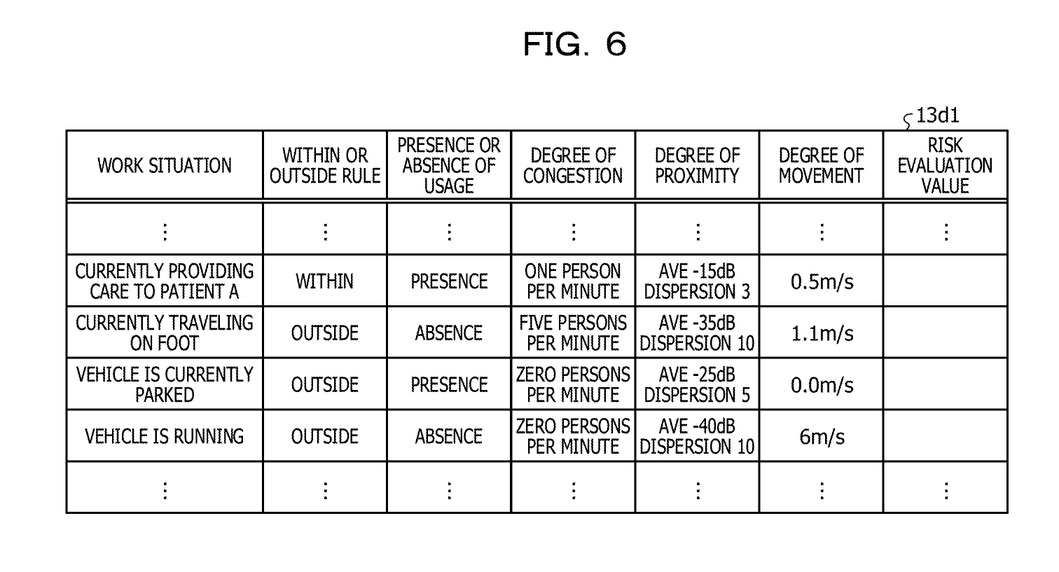

The calculation of the indexes is implemented in this way, thereby generating the risk evaluation information 13d1 illustrated in FIG. 6. FIG. 6 is a diagram illustrating an example of the risk evaluation information 13d1. FIG. 6 illustrates the risk evaluation information 13d1 generated in a case where the visiting medical care illustrated in FIG. 4 is performed. In addition, since, in this stage, risk evaluation values for generalizing the individual indexes are not calculated yet, the fields of the risk evaluation value are blank.

As illustrated in FIG. 6, as an example, the risk evaluation information 13d1 is data including items such as the work situation, within or outside a rule, the presence or absence of usage, the degree of congestion, the degree of proximity, the degree of movement, and the risk evaluation value. The term “within or outside a rule” here is an item indicating whether or not a work situation conforms to a condition specified in the rule information. The “presence or absence of usage” is an item indicating whether or not a service is used in the work situation. Furthermore, the “risk evaluation value” is an index obtained by comprehensively evaluating the degree of congestion, the degree of proximity, and the degree of movement.

The “work situation”, “within or outside a rule”, and the “presence or absence of usage” out of the items illustrated in FIG. 6 are described in conjunction with the generation of the log information 13c illustrated in FIG. 5. The end date and time is described in the record in the first line of the log information 13c illustrated in FIG. 5, thereby terminating the description of a record of the work situation of “currently providing care to the patient A”, for example. In this stage, in a record in the first line of the risk evaluation information 13d1 illustrated in FIG. 6, “currently providing care to the patient A” is described in the work situation, “within” is described in the “within or outside a rule”, and “presence” is described in the “presence or absence of usage”. The end date and time is described in the record in the second line of the log information 13c illustrated in FIG. 5, thereby terminating the description of a record of the work situation of “currently traveling on foot”. In this stage, in a record in the second line of the risk evaluation information 13d1 illustrated in FIG. 6, “currently traveling on foot” is described in the work situation, “outside” is described in the “within or outside a rule”, and “absence” is described in the “presence or absence of usage”. Furthermore, the end date and time is described in the record in the third line of the log information 13c illustrated in FIG. 5, thereby terminating the description of a record of the work situation of “a vehicle is currently parked”. In this stage, in a record in the third line of the risk evaluation information 13d1 illustrated in FIG. 6, “a vehicle is currently parked” is described in the work situation, “outside” is described in the “within or outside a rule”, and “presence” is described in the “presence or absence of usage”. After that, the end date and time is described in the record in the fourth line of the log information 13c illustrated in FIG. 5, thereby terminating the description of a record of the work situation of “a vehicle is running”. In this stage, in a record in the fourth line of the risk evaluation information 13d1 illustrated in FIG. 6, “a vehicle is running” is described in the work situation, “outside” is described in the “within or outside a rule”, and “absence” is described in the “presence or absence of usage”.

Regarding the degree of congestion, the degree of proximity, and the degree of movement out of the items illustrated in FIG. 6, in a stage in which the index calculation unit 15c calculates the degree of congestion, the degree of proximity, and the degree of movement from measurement information of an interval corresponding to one of individual work situations, values thereof are described in the respective fields of the degree of congestion, the degree of proximity, and the degree of movement. Since being calculated by the risk evaluation unit 15d to be described later, the risk evaluation value is set blank in this stage.

The risk evaluation unit 15d is a processing unit to calculate the risk evaluation value from the degree of congestion, the degree of proximity, and the degree of movement of a work situation, thereby evaluating a risk caused by the work situation.

As one embodiment, the risk evaluation unit 15d substitutes, into the following Expression (1), the degree of congestion, the degree of proximity, and the degree of movement, calculated by the index calculation unit 15c for each of the work situations, thereby calculating the corresponding risk evaluation value. “α”, “β”, and “γ” in the following Expression (1) are weight coefficients assigned to respective items of the degree of congestion, the degree of proximity, and the degree of movement. “The degree of congestion” is the degree of congestion of a work situation serving as a calculation target of the risk evaluation value. “The minimum degree of congestion” is the degree of congestion having a minimum value among individual work situations. “The maximum degree of congestion” is the degree of congestion having a maximum value among individual work situations. “The degree of proximity” is the degree of proximity of a work situation serving as a calculation target of the risk evaluation value, and here, an average value of a reception radio wave intensity is used therefor. “The minimum degree of proximity” is a minimum value among average values of reception radio wave intensities of the respective work situations. “The maximum degree of proximity” is a maximum value among the average values of reception radio wave intensities of the respective work situations. “The degree of movement” is the degree of movement of a work situation serving as a calculation target of the risk evaluation value. “The minimum degree of movement” is the degree of movement having a minimum value among the individual work situations. “The maximum degree of movement” is the degree of movement having a maximum value among the individual work situations.

Risk Evaluation Value=α×(Degree of Congestion−Minimum Degree of Congestion)/(Maximum Degree of Congestion−Minimum Degree of Congestion)+β×(Maximum Degree of Proximity−Degree of Proximity)/(Maximum Degree of Proximity−Minimum Degree of Proximity)+γ×(Degree of Movement−Minimum Degree of Movement)/(Maximum Degree of Movement−Minimum Degree of Movement) (1)

Here, as an example, examples of numerical value calculation of risk evaluation values of respective work situations will be described by using the degree of congestion, the degree of proximity, and the degree of movement included in the risk evaluation information 13d1 illustrated in FIG. 6. Here, as an example, a case of calculating under the assumption that the weight coefficient α is “2”, the weight coefficient β is “1”, and the weight coefficient γ is “2” will be exemplified. In the present example, in a case where a comparison of the degree of congestion is made among four work situations of “currently providing care to the patient A”, “currently traveling on foot”, “a vehicle is currently parked”, and “a vehicle is running”, the minimum degree of congestion is “zero persons per minute”, and the maximum degree of congestion is “five persons per minute”. In a case of a comparison of the degree of proximity, the minimum degree of proximity is “−40 dB”, and the maximum degree of proximity is “−15 dB”. Furthermore, in a case of a comparison of the degree of movement, the minimum degree of movement is “0 m/s”, and the maximum degree of movement is “6 m/s”.

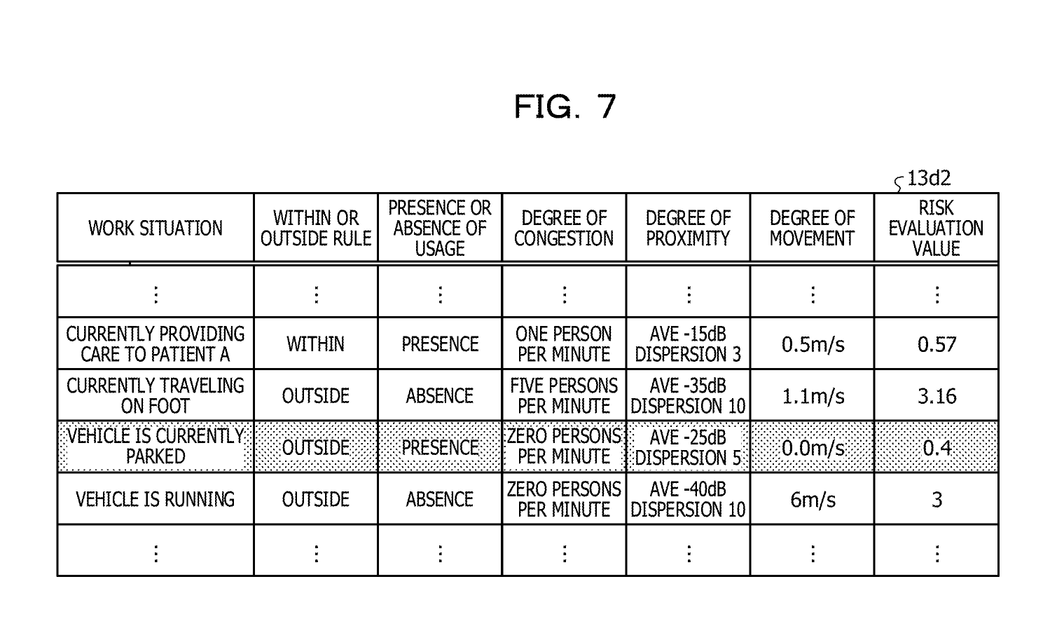

Under such assumption of the weight coefficients, the minimum degree of congestion, the maximum degree of congestion, the minimum degree of proximity, the maximum degree of proximity, the minimum degree of movement, and the maximum degree of movement, the degree of congestion, the degree of proximity, and the degree of movement of a work situation are substituted into the above-mentioned Expression (1), thereby calculating the risk evaluation value for each of the work situations, as illustrated in FIG. 7.

FIG. 7 is a diagram illustrating an example of the risk evaluation information 13d2. In FIG. 7, results obtained by calculating the risk evaluation values of the respective work situations by using the degree of congestion, the degree of proximity, and the degree of movement included in the risk evaluation information 13d1 illustrated in FIG. 6 are described in the fields of the risk evaluation values.

In a case of the work situation of “currently providing care to the patient A”, “one person per minute”, “45 dB”, and “0.5 m/s” are substituted into the degree of congestion, the degree of proximity, and the degree of movement, respectively, in the above-mentioned Expression (1), for example. In other words, based on calculation of “2×(1−0)/(5−0)+1×{−15−(−15)}/{−15−(−40)}+2×(0.5−0)/(6−0)”, it is possible to calculate the risk evaluation value. As a result, the term of the degree of congestion is calculated as “0.4”, based on calculation of “2×(1−0)/(5−0)”. The term of the degree of proximity is calculated as “0”, based on calculation of “1×{−15−(−15)}/{−15−(−40)}”. The term of the degree of movement is calculated as “0.166”, based on calculation of “2×(0.5−0)/(6−0)”. Therefore, it is possible to calculate, as “0.57 (≈0.4+0+0.166)”, the risk evaluation value of the work situation of “currently providing care to the patient A”.

In a case of the work situation of “currently traveling on foot”, “five persons per minute”, “−35 dB”, and “1.1 m/s” are substituted into the degree of congestion, the degree of proximity, and the degree of movement, respectively, in the above-mentioned Expression (1). In other words, based on calculation of “2×(5−0)/(5−0)+1×{−15−(−35)}/{−15−(−40)}+2×(1.1−0)/(6−0)”, it is possible to calculate the risk evaluation value. As a result, the term of the degree of congestion is calculated as “2”, based on calculation of “2×(5−0)/(5−0)”. The term of the degree of proximity is calculated as “0.8”, based on calculation of “1×{−15−(−35)}/{−15−(−40)}”. In addition, the term of the degree of movement is calculated as “0.36”, based on calculation of “2×(1.1−0)/(6−0)”. Therefore, it is possible to calculate, as “3.16 (≈2+0.8+0.36)”, the risk evaluation value of the work situation of “currently traveling on foot”.

Furthermore, in a case of the work situation of “a vehicle is currently parked”, “zero persons per minute”, “−25 dB”, and “0 m/s” are substituted into the degree of congestion, the degree of proximity, and the degree of movement, respectively, in the above-mentioned Expression (1). In other words, based on calculation of “2×(0−0)/(5−0)+1×{−15−(−25)}/{−15−(−40)}+2×(0−0)/(6−0)”, it is possible to calculate the risk evaluation value. As a result, the term of the degree of congestion is calculated as “0”, based on calculation of “2×(0−0)/(5−0)”. The term of the degree of proximity is calculated as “0.4”, based on calculation of “1×{−15−(−25)}/{−15−(−40)}”. In addition, the term of the degree of movement is calculated as “0”, based on calculation of “2×(0−0)/(6−0)”. Therefore, it is possible to calculate, as “0.4 (=0+0.4+0)”, the risk evaluation value of the work situation of “a vehicle is currently parked”.

In a case of the work situation of “a vehicle is running”, “zero persons per minute”, “−40 dB”, and “6 m/s” are substituted into the degree of congestion, the degree of proximity, and the degree of movement, respectively, in the above-mentioned Expression (1). In other words, based on calculation of “2×(0−0)/(5−0)+1×{−15−(−40)}/{−15−(−40)}+2×(6−0)/(6−0)”, it is possible to calculate the risk evaluation value. As a result, the term of the degree of congestion is calculated as “0”, based on calculation of “2×(0−0)/(5−0)”. The term of the degree of proximity is calculated as “1”, based on calculation of “1×{−15−(−40)}/{−15−(−40)}”. In addition, the term of the degree of movement is calculated as “2”, based on calculation of “2×(6−0)/(6−0)”. Therefore, it is possible to calculate, as “3 (=0+1+2)”, the risk evaluation value of the work situation of “a vehicle is running”.

By presenting such risk evaluation values to an operator, it is possible to give the operator an idea of rule correction to be described below.

In other words, according to the rule information 13b illustrated in FIG. 3, an operation in which a service for referencing the care information of the patient A is allowed to be used only if the work situation is “currently providing care to the patient A” is adopted. It may be said that such an operation is inadequate for an actual situation of an actual scene. The reason is that there is the following actual situation behind a background in which the doctor A uses a service even though “a vehicle is currently parked” falls outside a rule. In other words, in home healthcare, points of a statement of medical expenses increase with an increase in a time period during which a healthcare practitioner stays in a patient's home. Therefore, in a case where the healthcare practitioner stays in the patient's home for long, the burden of expenses of a patient increases. Out of consideration to such an aspect of a statement of medical expenses, a doctor prioritizes, in the patient' home, medical acts only permitted to be performed in the patient' home and postpones and performs, in a vehicle in which risks such as a contact with another person and a loss are low, a portion dedicated to an information and communication technology (ICT), for example, a work such as inputting of a medical record, in some cases. In this way, even in a case of service usage outside a rule, in which a balance between an actual situation of an actual scene and risks is ensured, it is difficult for the operator to get an idea that there is room for correction of a rule, the operator being hardly able to understand a risk at a time of the service usage outside the rule.

However, by displaying the risk evaluation value for each of the work situations in such a manner as in the risk evaluation information 13d2 illustrated in FIG. 7, it is possible to help the operator understand that, even in a case of service usage outside a rule, risks such as a contact with another person and a loss, caused by service usage in the work situation of “a vehicle is currently parked”, are low. For this reason, it becomes possible to give the operator an idea of adding a rule that a service is allowed to be used on condition that the work situation is “a vehicle is currently parked”.

The determination unit 15e is a processing unit to determine whether or not service usage outside a rule has validity.

As one embodiment, the determination unit 15e acquires records the validity of each of which is not determined yet, from the risk evaluation information 13d2 stored in the storage unit 13. Subsequently, the determination unit 15e determines whether or not a record for which a service is used in a work situation outside a rule exists among the previously extracted records not determined yet. At this time, in a case where a record for which a service is used in a work situation outside a rule exists, the determination unit 15e extracts records for each of which a service is used in a work situation within a rule, and calculates a statistical value x, for example, an average value of risk evaluation values included in the respective records. Furthermore, the determination unit 15e extracts records for each of which no service is used in a work situation outside a rule, and calculates a statistical value y, for example, an average value of risk evaluation values included in the respective records. On that basis, the determination unit 15e determines whether or not a risk evaluation value z included in the record for which a service is used in a work situation outside a rule is less than or equal to the above-mentioned statistical value x of risk evaluation values, in other word, z x is satisfied. In addition, in a case where the risk evaluation value z is less than or equal to the statistical value x of risk evaluation values, the determination unit 15e further determines whether or not the above-mentioned risk evaluation value z is less than the above-mentioned statistical value y of risk evaluation value, in other words, z<y is satisfied.

Here, in a case where the risk evaluation value z is less than or equal to the statistical value x of risk evaluation values and the risk evaluation value z is less than the statistical value y of risk evaluation values, risks such as a contact with another person and a loss are low compared with all work situations of the home medical care, and therefore, it is possible to determine that to allow a service to be used in the relevant work situation is valid. In this case, the determination unit 15e notifies the operator terminal 50 of a recommendation of rule correction for allowing a service to be used in the work situation for which the risk evaluation value z is calculated. On the other hand, in a case where the risk evaluation value z is more than the statistical value x of risk evaluation values or the risk evaluation value z is not less than the statistical value y of risk evaluation values, it is difficult to say that risks such as a contact with another person and a loss are low compared with all the work situations, and therefore, a proposal for rule correction is not implemented. In this case, the operator terminal 50 may be notified of a recommendation of implementing, based on hearing or the like, questioning of service usage outside a rule.

Regarding an example of the risk evaluation information 13d2 illustrated in FIG. 7, the risk evaluation value of “0.4” of the work situation of “a vehicle is currently parked” in which a service is used outside a rule is compared with the statistical value x of risk evaluation values and the statistical value y of risk evaluation values, for example. In this example, “currently providing care to the patient A” only exists as a work situation in which a service is used within a rule. Therefore, the statistical value x turns out to be the same value as the risk evaluation value of “0.57” of the work situation of “currently providing care to the patient A”. As work situations in each of which a service is used outside a rule, two work situations of “currently traveling on foot” and “a vehicle is running” exist. In this case, the statistical value y turns out to be “3.08=(3.16+3)/2” serving as the average value of the risk evaluation values of the work situations of “currently traveling on foot” and “a vehicle is running”. In a case where these statistical value x and statistical value y are compared with the risk evaluation value z, y>x>z is satisfied. Therefore, it is possible to determine that to allow a service to be used in the work situation of “a vehicle is currently parked” is valid. In this case, as an example, it is possible to output, to the rule information 13b illustrated in FIG. 3, a recommendation of rule correction for adding a record including a newly assigned rule ID, a condition of “the patient A's home beacon+the vehicle beacon+being parked”, and a service of “a service for referencing the care information of the patient A”.

Here, a case where the risk evaluation value z is compared with the two threshold values of the statistical value x of risk evaluation values and the statistical value y of risk evaluation values is exemplified. However, the risk evaluation value z does not have to be compared with the two threshold values. In a case where the risk evaluation value z is less than or equal to, for example, the statistical value x of risk evaluation values, it is equal to a risk caused by service usage within a rule or a risk caused by service usage outside the rule is lower than the risk caused by service usage within the rule. Therefore, it is possible to determine that there is plenty of room for rule correction. In this case, the above-mentioned recommendation of rule correction may be made. Here, a case of calculating, as an example of a statistical value, an average value is exemplified. However, statistical values such as a minimum value, a median value, a mode value, and a maximum value may be calculated.

The setting unit 15f is a processing unit to set a rule.

As one embodiment, the setting unit 15f performs addition, deletion, and editing of rules in accordance with setting operations received via the operator terminal 50. In a case where an approval operation for a recommendation of rule correction given notice of by the determination unit 15e is performed, the setting unit 15f adds, to the rule information 13b stored in the storage unit 13, a rule for allowing a service to be used in the work situation for which the risk evaluation value z is calculated, for example. Here, an example of adding a rule for the first time in a case where the approval operation from the operator terminal 50 is received is described. However, the approval operation may be skipped in a case where the risk evaluation value z is less than or equal to the statistical value x, thereby automatically adding a rule.

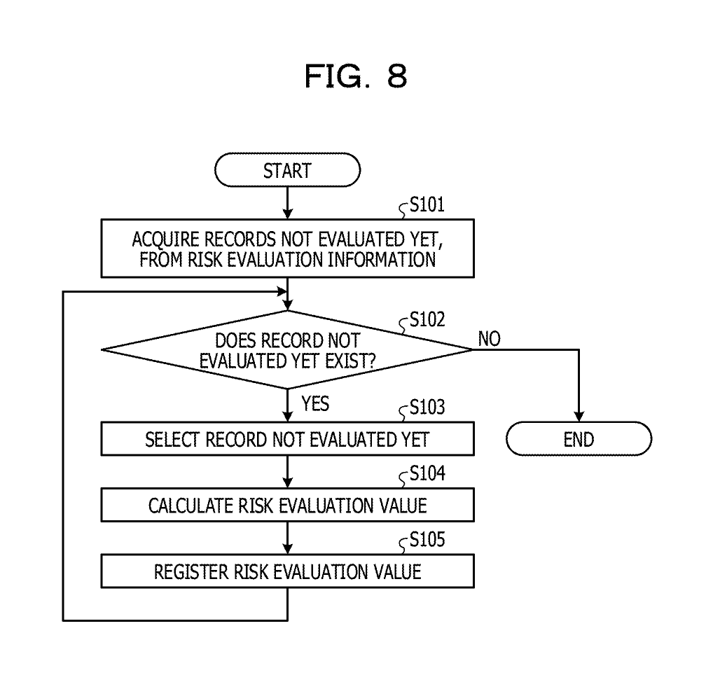

FIG. 8 is a flowchart illustrating a procedure of risk evaluation processing according to the first embodiment. As an example, this processing may be implemented every time the index calculation unit 15c calculates the degree of congestion, the degree of proximity, and the degree of movement for each of the work situations or may be implemented, based on batch processing, at a regular time, for example, at a medical care closing time of home medical care or a business closing time of a healthcare practitioner.

As illustrated in FIG. 8, from records included in the risk evaluation information 13d stored in the storage unit 13, the risk evaluation unit 15d acquires records the risk evaluation value of each of which is not calculated yet (S101). At this time, in a case where records the risk evaluation value of each of which is not calculated yet exist (S102: Yes), the risk evaluation unit 15d selects one of the records the risk evaluation value of each of which is not calculated yet and that are acquired in S101 (S103).

In addition, the risk evaluation unit 15d substitutes, into the above-mentioned Expression (1), the degree of congestion, the degree of proximity, and the degree of movement included in the record selected in S103, thereby calculating the risk evaluation value (S104). On that basis, the risk evaluation unit 15d registers, in the field of the risk evaluation value of the record selected in S103, the risk evaluation value calculated in S104 (S105), thereby making a transition to the processing operation in S102.

After that, as long as a record the risk evaluation value of which is not calculated yet exists, the processing proceeds to “Yes” in branching of S102, and the processing operations in S103 to S105 are repeatedly performed. In addition, in a case where no record the risk evaluation value of which is not calculated yet remains (S102: No), the processing is terminated.

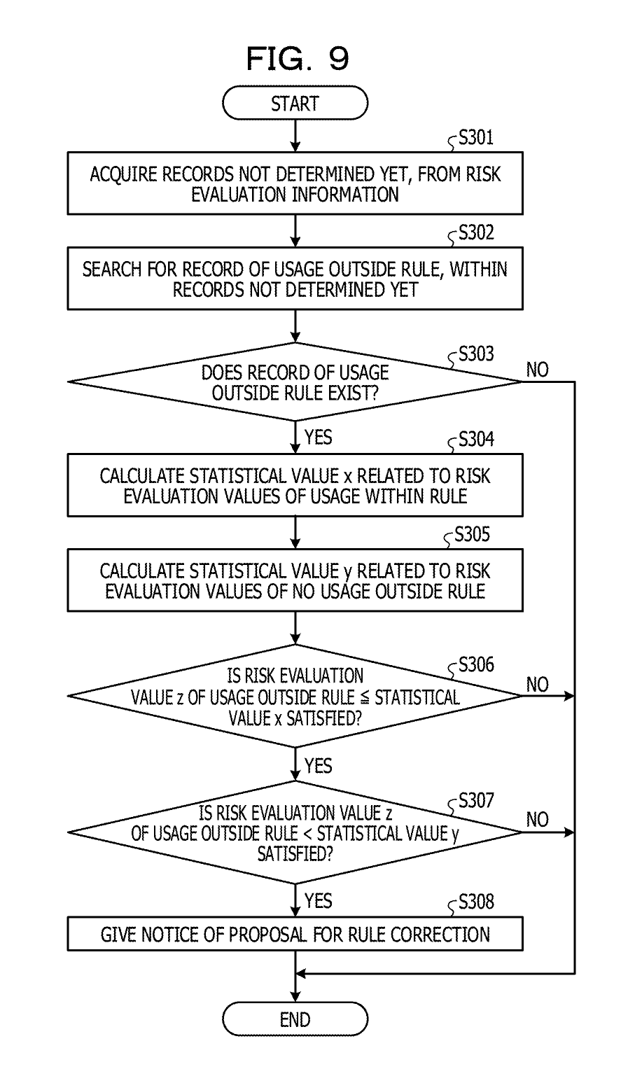

FIG. 9 is a flowchart illustrating a procedure of determination processing according to the first embodiment. Regarding this processing, as an example, the processing may be started on condition that a record for which the validity of allowing a service to be used is not determined yet exists in the risk evaluation information 13d stored in the storage unit 13. This processing may be implemented, based on batch processing, at a regular time, for example, at a medical care closing time of home medical care or a business closing time of a healthcare practitioner.

As illustrated in FIG. 9, the determination unit 15e acquires records for each of which the validity of allowing a service to be used is not determined yet, from the risk evaluation information 13d stored in the storage unit 13 (S301). Subsequently, the determination unit 15e searches for a record for which a service is used in a work situation outside a rule, within the records acquired in S301 (S302). In a case where no record for which a service is used in a work situation outside a rule is hit (S303: No), the processing is terminated without change.

On the other hand, in a case where a record for which a service is used in a work situation outside a rule is hit (S303: Yes), the determination unit 15e extracts records for each of which a service is used in a work situation within a rule, from records of the risk evaluation information 13d, and calculates the statistical value x of risk evaluation values included in the respective records (S304). Furthermore, the determination unit 15e extracts, from the records of the risk evaluation information 13d, records for each of which no service is used in a work situation outside a rule, and calculates the statistical value y of risk evaluation values included in the respective records (S305).

On that basis, the determination unit 15e determines whether or not the risk evaluation value z included in the record for which a service is used in a work situation outside a rule is less than or equal to the statistical value x of risk evaluation values, calculated in S304, in other word, z x is satisfied (S306).

In addition, in a case where the risk evaluation value z is less than or equal to the statistical value x of risk evaluation values (S306: Yes), the determination unit 15e further determines whether or not the above-mentioned risk evaluation value z is less than the statistical value y of risk evaluation value, calculated in S305, in other words, z<y is satisfied (S307).

Here, in a case where the risk evaluation value z is less than the statistical value y of risk evaluation values (S307: Yes), risks such as a contact with another person and a loss are low compared with all work situations of the home medical care, and therefore, it is possible to determine that to allow a service to be used in the relevant work situation is valid. In this case, the determination unit 15e notifies the operator terminal 50 of a recommendation of rule correction for allowing a service to be used in the work situation for which the risk evaluation value z is calculated (S308), and terminates the processing.

On the other hand, in a case where the risk evaluation value z is more than the statistical value x of risk evaluation values or the risk evaluation value z is not less than the statistical value y of risk evaluation values (S306: No or S307: No), it is difficult to say that risks such as a contact with another person and a loss are low compared with all the work situations, and therefore, a proposal for rule correction is not implemented. In this case, the processing is terminated without change.

As described above, for each of work situations, the server device 10 according to the present embodiment calculates risk evaluation values around a terminal in which a service having a high level of privacy is used, from sensor information measured by the terminal during a time period between a transition of a situation work in the terminal and a subsequent transition of a situation work. Therefore, it is possible to help the operator understand that risks such as a contact with another person and a loss, caused by service usage in each of the work situations, are low. Therefore, based on the server device 10 according to the present embodiment, it becomes possible to adequately correct a rule.

### Second Embodiment

By the way, as above, an embodiment related to the disclosed device is described. However, in addition to the above-mentioned embodiment, the present technology may be implemented in various different embodiments. Therefore, hereinafter, another embodiment included in the present technology will be described.

While, in the above-mentioned first embodiment, a case of applying the risk evaluation processing and the determination processing to the home medical care support system 1 is exemplified, a field of application is not limited to the field of home medical care. In addition to, for example, an insurance market in which insurance salespersons are assisted to visit homes, pieces of information each having a high level of privacy, such as injury and disease states, asset situations, and account information, are used for external visits in a financial and securities market in which sales representatives of financial and securities institutions are assisted to visit homes. Therefore, the risk evaluation processing and the determination processing may be applied thereto in the same way.

In the above-mentioned first embodiment, a case where, based on a relative comparison between the risk evaluation value z, included in a record for which a service is used in a work situation outside a rule, and the statistical value x of risk evaluation values included in records for each of which a service is used in a work situation within a rule, the validity of allowing a service to be used is determined is exemplified, there is no limitation to this. Based on whether or not the above-mentioned risk evaluation value z is less than or equal to a predetermined threshold value th, the validity of allowing a service to be used may be determined, for example.

The individual configuration items of each of the illustrated devices do not have to be physically configured as illustrated. In other words, specific states of the distribution or integration of the individual devices are not limited to these illustrated in the drawings, and all or part of the individual devices may be functionally or physically distributed or integrated in arbitrary units depending on various loads, various usage situations, and so forth. The service providing unit 15a, the log generation unit 15b, the index calculation unit 15c, the risk evaluation unit 15d, the determination unit 15e, or the setting unit 15f may be coupled, as external devices of the server device 10, via the network NW, for example. The service providing unit 15a, the log generation unit 15b, the index calculation unit 15c, the risk evaluation unit 15d, the determination unit 15e, and the setting unit 15f may be included in other respective devices and may be network-coupled so as to cooperate with one another, thereby realizing the functions of the above-mentioned server device 10.

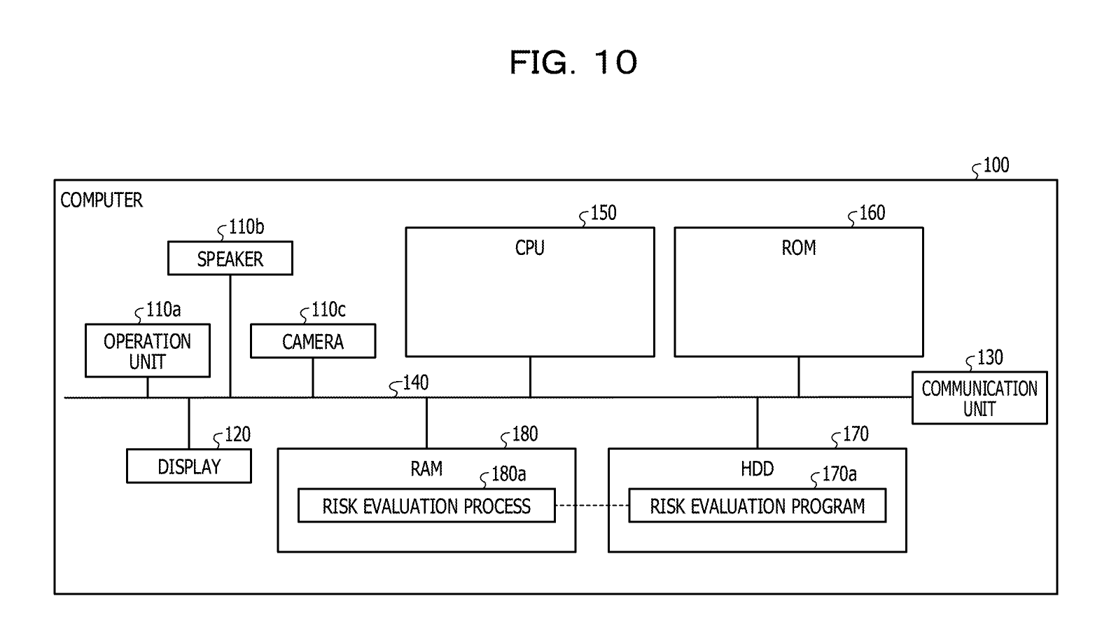

A computer such as a personal computer or a workstation may execute a preliminarily prepared program, thereby realizing the various processing operations described in the above-mentioned embodiment. Therefore, hereinafter, an example of a computer to execute a risk evaluation program having the same functions as those of the above-mentioned embodiment will be described by using FIG. 10.

FIG. 10 is a diagram illustrating an example of a hardware configuration of a computer to execute a risk evaluation program according to the first embodiment and a second embodiment. As illustrated in FIG. 10, a computer 100 includes an operation unit 110a, a speaker 110b, a camera 110c, a display 120, and a communication unit 130. Furthermore, this computer 100 includes a CPU 150, a ROM 160, an HDD 170, and a RAM 180. These individual units 110 to 180 are coupled to one another via a bus 140.

As illustrated in FIG. 10, a risk evaluation program 170a to fulfil the same functions as those of the index calculation unit 15c, the risk evaluation unit 15d, and the determination unit 15e illustrated in the above-mentioned first embodiment is stored in the HDD 170. This risk evaluation program 170a may be integrated or separated in the same way as the individual configuration items of the index calculation unit 15c, the risk evaluation unit 15d, and the determination unit 15e illustrated in FIG. 1. In other words, all pieces of data illustrated in the above-mentioned first embodiment do not have to be stored in the HDD 170, and data used for processing only has to be stored in the HDD 170. In place of the above-mentioned risk evaluation program 170a, a home medical care support program including the individual functions of the service providing unit 15a, the log generation unit 15b, the index calculation unit 15c, the risk evaluation unit 15d, the determination unit 15e, and the setting unit 15f may be stored in the HDD 170.

Under such an environment, after reading the risk evaluation program 170a from the HDD 170, the CPU 150 deploys the risk evaluation program 170a in the RAM 180. As a result, as illustrated in FIG. 10, the risk evaluation program 170a functions as a risk evaluation process 180a. This risk evaluation process 180a deploys various pieces of data read from the HDD 170, in an area, which is allocated to the risk evaluation process 180a and which is included in a storage area included in the RAM 180, and performs various kinds of processing by using the deployed various pieces of data. As examples of processing operations performed by the risk evaluation process 180a, processing operations illustrated in FIG. 8 to FIG. 9 and so forth are included, for example. In the CPU 150, all the processing units illustrated in the above-mentioned first embodiment do not have to operate, and processing units corresponding to processing serving as an execution target only have to be virtually realized.

The above-mentioned risk evaluation program 170a does not have to be stored in the HDD 170 or the ROM 160 from the beginning. The risk evaluation program 170a is caused to be stored in “portable physical media” such as a flexible disk (a so-called FD), a CD-ROM, a DVD disk, a magneto-optical disk, and an IC card, which are to be inserted into the computer 100, for example. In addition, the computer 100 may acquire, from one of these portable physical media, and execute the risk evaluation program 170a. Another computer and a server device, coupled to the computer 100 via a public line, the Internet, a LAN, or a WAN, may be caused to preliminarily store therein the risk evaluation program 170a, and the computer 100 may acquire, from one of these, and execute the risk evaluation program 170a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A risk evaluation method executed by a processor included in a risk evaluation device, the risk evaluation method comprising:
receiving, from a terminal device that includes a sensor and that is configured to receive a service, sensor information acquired by the sensor during a time period between sensing of a transition of a work situation and sensing of a subsequent transition, performed by the terminal device;
calculating, from the received sensor information, a risk evaluation value obtained by indexing a risk around the terminal device;
determining whether the risk evaluation value is less than or equal to a predetermined threshold value; and
notifying a management device to manage the terminal device of information based on a result of the determining when it is determined that the risk evaluation value is less than or equal to the predetermined threshold value.

2. The risk evaluation method according to claim 1,
wherein the determining includes determining whether a first risk evaluation value calculated in a case where the service is used by a user of the terminal device in a work situation not conformable to a rule for using the service is less than or equal to a second risk evaluation value calculated in a case where the service is used in a work situation conformable to the rule.

3. The risk evaluation method according to claim 2, further comprising:
determining whether the first risk evaluation value is less than a third risk evaluation value calculated in a case where the service is not used in a work situation not conformable to the rule, when it is determined that the first risk evaluation value is less than or equal to the second risk evaluation value,
wherein the notifying includes notifying of information based on the result of the determination when it is determined that the first risk evaluation value is less than the third risk evaluation value.

4. The risk evaluation method according to claim 3,
wherein the information based on the result of the determining is a proposal for correcting the rule.

5. The risk evaluation method according to claim 1,
wherein the risk evaluation value is one of a degree of congestion around the terminal device, a degree of proximity of the terminal device to a user of the terminal device and a movement velocity of the terminal device, or a combination thereof.

6. The risk evaluation method according to claim 1,
wherein the sensor information is one of location information of the terminal device, sound information around the terminal device and acceleration information of the terminal device, or a combination thereof.

7. The risk evaluation method according to claim 1, wherein the terminal device is configure to:
receive a beacon, and
determine that the work situation makes a transition, when a transmission source of the received beacon changes.

8. The risk evaluation method according to claim 7,
wherein the received beacon is one of a beacon transmitted by an oscillator of a user of the terminal device, a beacon transmitted by an oscillator installed in a workplace of the user, a beacon transmitted by an oscillator of an attendant who attends the user and a beacon transmitted by an oscillator installed in a vehicle used by the user, or a combination thereof.

9. A risk evaluation device, comprising:
a memory; and
a processor coupled to the memory and the processor configured to:
receive, from a terminal device that includes a sensor and that is configured to receive a service, sensor information acquired by the sensor during a time period between sensing of a transition of a work situation and sensing of a subsequent transition, performed by the terminal device;
calculate, from the received sensor information, a risk evaluation value obtained by indexing a risk around the terminal device;
determine whether the risk evaluation value is less than or equal to a predetermined threshold value; and
notify a management device to manage the terminal device of information based on a result of the determination when it is determined that the risk evaluation value is less than or equal to the predetermined threshold value.

10. The risk evaluation device according to claim 9,
wherein the processor is configured to determine whether a first risk evaluation value calculated in a case where the service is used by a user of the terminal device in a work situation not conformable to a rule for using the service is less than or equal to a second risk evaluation value calculated in a case where the service is used in a work situation conformable to the rule.

11. The risk evaluation device according to claim 10, wherein the processor is configured to:
determine whether the first risk evaluation value is less than a third risk evaluation value calculated in a case where the service is not used in a work situation not conformable to the rule, when it is determined that the first risk evaluation value is less than or equal to the second risk evaluation value, and
notify the management device of information based on the result of the determination when it is determined that the first risk evaluation value is less than the third risk evaluation value.

12. The risk evaluation device according to claim 11,
wherein the information based on the result of the determining is a proposal for correcting the rule.

13. The risk evaluation device according to claim 12,
wherein the risk evaluation value is one of a degree of congestion around the terminal device, a degree of proximity of the terminal device to a user of the terminal device and a movement velocity of the terminal device, or a combination thereof.

14. A non-transitory computer-readable storage medium storing a program that causes a processor included in an information processing device to execute a process, the process comprising:
receiving, from a terminal device that includes a sensor and that is configured to receive a service, sensor information acquired by the sensor during a time period between sensing of a transition of a work situation and sensing of a subsequent transition, performed by the terminal device;
calculating, from the received sensor information, a risk evaluation value obtained by indexing a risk around the terminal device;
determining whether the risk evaluation value is less than or equal to a predetermined threshold value; and
notifying a management device to manage the terminal device of information based on a result of the determination when it is determined that the risk evaluation value is less than or equal to the predetermined threshold value.
